(19) United States
(12) Patent Application Publication
(10) Pub. No.: US 2024/0401318 A1
(43) Pub. Date: Dec. 5, 2024

(54) FLUSHING SYSTEM AND INTELLIGENT TOILET

(71) Applicant: ZHEJIANG IKAHE SANITARY WARE CO., LTD., Taizhou (CN)

(72) Inventors: Huan ZHAO, Taizhou (CN); Guangqi XU, Taizhou (CN); Rui LIU, Taizhou (CN)

(73) Assignee: ZHEJIANG IKAHE SANITARY WARE CO., LTD., Taizhou (CN)

(21) Appl. No.: 18/623,047

(22) Filed: Apr. 1, 2024

(30) Foreign Application Priority Data
Jun. 2, 2023 (CN) 202310652988.9

(51) Int. Cl. E03D 1/32; E03D 1/28; E03D 1/33; E03D 1/34

(52) U.S. Cl. CPC E03D 1/32; E03D 1/286; E03D 1/33; E03D 1/34

(57) ABSTRACT

The application discloses a flushing system and an intelligent toilet. The flushing system includes a sealed water tank including a tank body and a tank cover connected to the tank body in a sealed way by hot plate welding process and an integrated mechanical valve. The integrated mechanical valve is set on the tank cover, is connected to the tank cover in a sealed way, and includes a water inlet, a water supplementation inlet connected to the water inlet, a water outlet at the water supplementation inlet and away from the water inlet, a buoy mechanism at the water supplementation inlet and a pressing connecting rod structure between the water inlet and the water outlet where the buoy mechanism controls the switch of the water supplementation inlet based on the water level and the pressing connecting rod structure controls the switch at the water outlet by pressing.

### CROSS-REFERENCE TO RELATED APPLICATION

The present application claims the benefit of priority to Chinese Patent Application No. 202310652988.9, filed on Jun. 2, 2023, which is hereby incorporated by reference in its entirety.

### TECHNICAL FIELD

The application relates to an intelligent sanitary product field, in particular to a flushing system and an intelligent toilet.

### TECHNICAL BACKGROUND

The flushing systems of existing intelligent toilet products in the industry are generally divided into two types, i.e., “zero water pressure” type and “no water tank” type.

The zero water pressure type flushing system realizes the flushing function by setting a water tank in the intelligent toilet, sucking the water from the water tank with a water pump, and passing through the water way switching valve, without the need of external water supply under pressure. The no water tank type flushing system is free of a built-in water tank and directly realizes the flushing when the external water under pressure passes through the water way switching valve.

Of the two types above, the zero water pressure type flushing system has the advantages of no requirement for external water pressure, and stable flushing performance, but has the disadvantages of large space occupation by the built-in water tank, high total relative costs, and need of large-capacity battery for driving the water pump when there is power failure. The no water tank type flushing system has the advantages of small internal space occupation, relatively low total costs, and realization of application in power failure via a mechanical mechanism, but has the disadvantages of requiring minimum pressure of external water supply and deteriation of the flushing performance when water pressure is low.

### SUMMARY

The application provides a flushing system and an intelligent toilet to solve the technical problems of related art that the flushing function of zero water pressure type products is disabled in a power-off state and there is the requirement for minimum water inlet pressure of no water tank type products.

To solve the above technical problems, a technical scheme in the application provides a flushing system. The flushing system includes a sealed water tank, which includes a tank body and a tank cover connected to the tank body in a sealed way by hot plate welding process. The flushing system also includes an integrated mechanical valve set on the tank cover and connected to the tank cover in a sealed way; a water inlet; a water supplementation inlet connected to the water inlet; a water outlet at the water supplementation inlet and away from the water inlet; a buoy mechanism at the water supplementation inlet; and a pressing connecting rod structure between the water inlet and the water outlet. The buoy mechanism controls the switch of the water supplementation inlet based on the water level and the pressing connecting rod structure controls the switch at the water outlet by pressing.

In some embodiments, the sealed water tank includes a DC variable frequency water pump and a shunt valve which connects the water outlet of the DC variable frequency water pump and includes a lateral flushing outlet and a bottom flushing outlet so as to realize the switching between the lateral flushing outlet and the bottom flushing outlet by controlling the core of the shunt valve.

In some embodiments, the water outlets of the integrated mechanical valve include an upper flushing outlet and a lower flushing outlet. The integrated mechanical valve includes a switching valve core configured to switch the upper flushing outlet and the lower flushing outlet and a delay reset mechanism connected to the pressing connecting rod structure in parallel. The delay reset mechanism slowly switches the switching valve core from the lower flushing outlet to the upper flushing outlet.

In some embodiments, the upper flushing outlet of the integrated mechanical valve and the lateral flushing outlet of the shunt valve are connected to the lateral flushing nozzle with a lateral flushing tee to realize the lateral flushing.

In some embodiments, the shunt valve includes a shunt valve core, a rotation shaft on the shunt valve core, a shunt valve cover on one side of the shunt valve core away from the tank body and a shunt valve motor which is connected to the rotation shaft and is fixed on the shunt valve cover. In some embodiments, the shunt valve motor drives the rotation of the rotation shaft to drive the rotation of the shunt valve core for the purpose of realizing opening and closing of the bottom flushing outlet.

In some embodiments, a position between the lateral flushing tee and the lateral flushing nozzle is set with a lateral flushing suction pipe of which the lateral wall is set with a suction tee which includes two water inlets and one water outlet. One water inlet is connected to the external water way, the other water inlet is connected to the auxiliary liquid tank with the foam liquid of the sealed water tank with a hose and the water outlet is connected to the lateral flushing nozzle to suck the foam liquid from the auxiliary liquid tank by the Venturi effect of the suction tee and mix with the liquid in the lateral flushing suction pipe.

In some embodiments, the lateral flushing suction pipe is set with a lateral flushing flocculent flow film at the water outlet of the suction tee.

In some embodiments, the lower flushing outlet of the integrated mechanical valve and the bottom flushing outlet of the shunt valve are connected to a bottom flushing nozzle at the bottom of the toilet with two water pipes. The bottom flushing nozzle includes two water inlets and one water outlet which corresponds to the drainage outlet of the toilet.

In some embodiments, the tank cover of the sealed water tank is set with an air inlet and an auxiliary buoy corresponding to the air inlet. The auxiliary buoy moves towards the air inlet under the action of the rising water level. The air inlet is closed when the water level rises to a set water level to form a closed air chamber.

To solve the above technical problems, another technical scheme adopted in this application is an intelligent toilet including a toilet and a flushing system connected to the toilet with a pipe, where the flushing system can be any of the above-mentioned flushing systems.

The beneficial effects of the application are that different from related art, the application realizes the storage function of the water tank by the buoy mechanism on the integrated mechanical valve to ensure water stored in the water tank and realize the flushing function by utilizing the water stored in the water tank in a power on state. In a power-off state, open the water outlet by pressing connecting rod structure and directly use the tap water to realize the flushing function. It can solve the technical problems of related art that the flushing function of zero water pressure type products is disabled in a power-off state and there is the requirement for minimum water inlet pressure of no water tank type products.

### BRIEF DESCRIPTION OF DRAWINGS

FIG. 1 illustrates a schematic diagram of explosive structure of an embodiment of a flushing system; and

FIG. 2 illustrates a schematic diagram of explosive structure of an embodiment of an intelligent toilet.

### DETAILED DESCRIPTION

The following content is the clear and complete description of the technical schemes in the embodiments in the application according to the figures of the embodiments. Obviously, the described embodiments are only some embodiments of the application, not all embodiments. All other embodiments obtained by ordinary persons skilled in the art based on the embodiments in the application without creative labor are within the scope of protection of the application.

The terms “firstly,” “secondly,” and “thirdly” in the application are only to describe the purpose and cannot be understood as the indication or implication of relative importance or the implication of the quantity of technical features indicated. Therefore, the features limited by “first,” “second,” and “third” may explicitly or implicitly include at least one of these features. Among the descriptions in the application, “many” means at least two, i.e. two, three or more, unless otherwise specified. All direction indications, such as above, below, left, right, front, and behind, in embodiments in the application, are only to explain the relative positional relationships and motion situations of components in a specific state (as shown in the figures). If the specific state changes, the direction indication also changes. In addition, the terms “include,” “own,” and other deformation forms intentionally cover the non-exclusive inclusion. For example, a process, method, system, product, or device that includes a series of steps or units is not limited to the listed steps or units, but also, in some embodiments, includes steps or units not listed or, in some embodiments, includes other steps or units for these processes, methods, products, or devices.

The “embodiment” in the application means that the specific features, structures or characteristics described by combining with the embodiment may be included in at least one embodiment of the application. The term in various positions in the specifications does not necessarily refer to the same embodiment, nor is it an independent or alternative embodiment that is mutually exclusive with other embodiments. The persons skilled in the art explicitly and implicitly understand that the embodiments described in the application can be combined with other embodiments.

The following content is the detailed description of the application based on the figures and the embodiments.

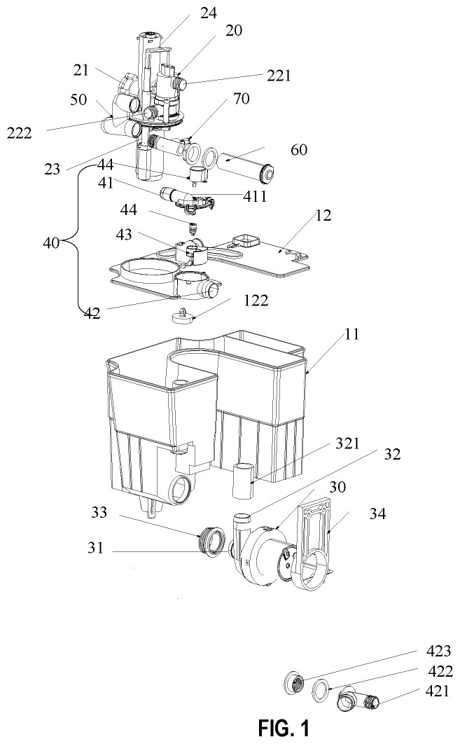

FIG. 1 illustrates a schematic diagram of explosive structure of an embodiment of a flushing system.

The application provides a flushing system. Referring to FIG. 1, the flushing system at least includes a sealed water tank 10 or an integrated mechanical valve 20.

In some embodiments, the sealed water tank 10 includes a tank body 11 and a tank cover 12 connected to the tank body 11 in a sealed way by hot plate welding process. In some embodiments, the tank body 11 stores the liquid including foam and water. The tank body 11 also can include a main liquid tank and an auxiliary liquid tank. The main liquid tank stores the tap water and the auxiliary liquid tank stores the foam liquid. The type of liquid stored in the main liquid tank and the auxiliary liquid tank is not limited herein. The hot plate welding process is adopted at the connection position between the tank cover 12 and the tank body 11 to form a sealed connection between the tank body 11 and the tank cover 12.

The integrated mechanical valve 20 is set on the tank cover 12 and is connected to the tank cover 12 with a sealing ring in a sealed way. The integrated mechanical valve 20 includes a water inlet 21, a water supplementation inlet connected to the water inlet 21, a water outlet, a buoy mechanism 23 at the water supplementation inlet, and a pressing connecting rod structure 24 between the water inlet 21 and the water outlet. In some embodiments, the water supplementation inlet is set at the junction of the integrated mechanical valve 20 and the tank cover 12. The switch of the water supplementation inlet is controlled by the buoy mechanism 23 passing through the tank cover 12 and extending to the bottom of the tank body 11. The buoy mechanism 23 includes a buoy connected to a lever. The buoy moves towards the air inlet under the action of the rising water level. When the water level reaches the set water level, the buoy contacts the water tank inlet so as to control the switch of the water supplementation inlet to realize the water feeding functions. In some embodiments, the buoy mechanism 23 is set close to the water inlet 21 to ensure the water feeding function of water tank, i.e., in front of the pressing connecting rod structure 24.

In some embodiments, the water inlet is the total water feeding way. The water is fed to the water tank when the buoy mechanism controls the water supplementation inlet to open. After the water level reaches the set level, the buoy comes up to drive the buoy mechanism to control the water supplementation inlet to switch to a closed state. The water outlet is opened by the pressing connecting rod structure so as to realize the flushing function.

The beneficial effects of the embodiment are that the buoy mechanism of the integrated mechanical valve realizes the storage function of the water tank and ensures the water stored in the water tank, and the water is pumped up from the water tank if there is water in the water tank to realize the flushing function. In a power-off state, the water outlet is opened with the pressing connecting rod structure so that the water at the water inlet directly flows into the toilet from the water outlet to realize the flushing function. Therefore, it solves the technical problems of related art that the flushing function of zero water pressure type products is disabled in a power-off state and that no water tank type products require minimum water inlet pressure.

It should be noted that the integrated mechanical valve prioritizes the water feeding function of the water tank. When the water level of the water tank reaches the set water level, the water supplementation inlet is closed and the pressing connecting rod structure is enabled to realize the tap water flushing function. Otherwise, the water feeding function of the water tank will be prioritized.

In some embodiments, the water outlets of the integrated mechanical valve 20 include an upper flushing outlet 221 and a lower flushing outlet 222 to realize the lateral and bottom flushing of toilets. In other embodiments, one or more water outlets can be set without limitation hereby. The integrated mechanical valve 20 includes a switching valve core (not indicated in the figure) to switch the upper flushing outlet 221 and the lower flushing outlet 222. The switching valve core is set in the pressing connecting rod structure. In some embodiments, the upper flushing outlet 221 and the lower flushing outlet 222 are set in upper and lower positions of the pressing connecting rod structure 24. The pressing distance of the pressing connecting rod structure 24 is controlled so that the switching valve core realizes the switching of the upper flushing outlet 221 and the lower flushing outlet 222. In some embodiments, the integrated mechanical valve 20 also includes a delay reset mechanism (not indicated in the figure) connected to the pressing connecting rod structure 24 in parallel. The delay reset mechanism can store the pressing kinetic energy of the pressing connecting rod structure 24. After releasing the pressing connecting rod structure 24, the delay reset mechanism starts to slowly switch the switching valve core from the lower flushing outlet 222 to the upper flushing outlet 221. The specific implementation mode includes the following operations: click to press the pressing connecting rod structure; the action force of the pressing connecting rod structure is used for accumulating the kinetic energy for the parallel delay reset mechanism; after releasing, the delay reset mechanism starts to slowly switch the valve core from the lower flushing outlet to the upper flushing outlet; during switching, the lower flushing outlet firstly starts flushing and then stops flushing several seconds later; then, the upper flushing outlet firstly starts flushing and then stops flushing several seconds later; then the delay reset mechanism completes the reset action. In this embodiment, both the upper flushing outlet 221 and the lower flushing outlet 222 are set with the check valves to avoid the back flow.

Furthermore, the sealed water tank 10 includes a DC variable frequency water pump 30 connected to the tank body 11 and a shunt valve 40 connected to the water outlet of the DC variable frequency water pump 30 so that the sealed water tank 10 pumps the water out of the water tank in power on state to realize the flushing function. In other embodiments, other structures can provide the kinetic energy for water in the water tank to pump the water out of the water tank so as to realize the flushing function which is not limited hereby.

In some embodiments, the DC variable frequency water pump 30 is set outside the tank body 11. In other embodiments, the DC variable frequency water pump 30 can be set in the water tank which is not limited hereby. Specifically, the DC variable frequency water pump 30 includes a water pump inlet 31 and a water pump outlet 32. The water pump inlet 31 is set corresponding to the bottom of the tank body 11 and is immersed in liquid in the water tank to pump the liquid in the tank body 11 via the water pump outlet 32. In some embodiments, the water pump outlet 32 is used for controlling the flowing direction of the liquid. Specifically, DC variable frequency water pump 30 is set corresponding to the lower section of the tank body 11, i.e., the bottom of the tank body 11, and is set outside the tank body 11 so as to save the space of water tank. Specifically, the water pump inlet 31 of the DC variable frequency water pump 30 is connected to the side wall of the tank body 11 in a sealed way with a water pump sealing ring. The water pump outlet 32 is connected to the shunt valve 40 on the tank cover 12 so as to pump the water out of the water tank and to the ceramic toilet with the shunt valve 40. In some embodiments, the shunt valve 40 controls the direction of water flow. In other embodiments, the shunt valve 40 is not necessary and only realizes one function of the lateral flushing or the bottom flushing which is not limited hereby. In some embodiments, the DC variable frequency water pump 30 is connected to the tank body 11 in a flexible way with the flexible connector 33. In some embodiments, the flexible connection can reduce the impact of vibration transmission on external connections during the operation of the water pump. The water pump outlet 32 of the DC variable frequency water pump 30 is connected to a lateral wall transmission pipe 321 integrated with the water tank to transmit the water to the shunt valve 40. When starting the flushing function, the water in the water tank is pumped and transmitted to the shunt valve 40 with the water pump and the side wall transmission pipe 321 on the water tank. In some embodiments, the side wall transmission pipe 321 can be hose and be connected to the tank body 11 in a flexible way to reduce the vibration. In some embodiments, the DC variable frequency water pump 30 includes a water pump fixing support 34 to fix the DC variable frequency water pump 30 so as to further reduce the vibration and displacement of the DC variable frequency water pump 30. Specifically, the water pump fixing support 34 is used to fix the DC variable frequency water pump 30 on the ceramic toilets. In other embodiments, the water pump fixing support 34 is not necessary or is fixed on the tank body 11 which is not limited hereby.

In the embodiment, the shunt valve 40 includes a lateral flushing outlet 41, a bottom flushing outlet 42, and the shunt valve core 43 controlling the switch of the bottom flushing outlet 42. The shunt valve core 43 is rotated to control the opening and closing of the lateral flushing outlet 41. The bottom flushing outlet 42 is set on the tank cover 12. The lateral flushing outlet 41 is set on the shunt valve cover to change the direction of the lateral flushing outlet 41 which is not limited hereby.

Furthermore, the shunt valve 40 includes a shunt valve core 43, a rotation shaft 44 on the shunt valve core 43, a shunt valve cover 411 on one side of the shunt valve core 43 away from the tank body 11, and a shunt valve motor 45 connected to the rotation shaft 44 and fixed on the shunt valve cover 411. In some embodiments, the shunt valve motor 45 drives the rotation of the rotation shaft 44 to drive the rotation of the shunt valve core 43 for the purpose of realizing opening and closing of the bottom flushing outlet 42. In other embodiments, other devices can be used to control the open and close state of the shunt valve plate which is not limited hereby. In some embodiments, the shunt valve cover 411 is fixed on and connected to the water tank cover 12 in a sealed way via the fixed base to fix the shunt valve 40. In addition, the shunt valve core 43 and the rotation shaft 44 are sealed in the tank body. The shunt valve motor 45 is fixed on the shunt valve cover 411 away from the shunt valve core 43 and is connected to the rotation shaft 44 via the through-hole on the shunt valve cover 411 so as to control the operation of the shunt valve. In other embodiments, the shunt valve motor 45 can be set in the shunt valve which is not limited hereby. In some embodiments, the lateral flushing outlet 41 is set on one side of the shunt valve cover 411. The bottom flushing outlet 42 is set corresponding to the shunt valve on the tank cover 12.

The specific implementation mode includes: in power-based flushing, the water in the water tank flows to the shunt valve under the kinetic energy provided by the DC variable frequency water pump; at the beginning of flushing, the shunt valve plate closes the flushing way and the water transmitted by the water pump is transmitted to the lateral flushing nozzle from the shunt valve lateral flushing outlet and is sprinkled to the inner space of the ceramic toilets to form a vortex flushing effect; at this time, the shunt valve plate is switched to a position where the lateral flushing outlet is half close and the bottom flushing outlet is fully open. The water transmitted by the water pump is transmitted to the bottom flushing nozzle from the shunt valve bottom flushing outlet and is sprinkled to the inner space of the ceramic toilets to form a siphon jet effect. When the water in the ceramic toilet is fully drained by the siphon action and the siphon stops, the water from the lateral flushing nozzle continuously supplements and the water seal is recovered so as to finish a complete flushing function. In some embodiments, the lateral flushing outlet 41 is set with a normally open check valve (not indicated in the figure). During flushing, the lateral flushing outlet 41 is in a normally open state to ensure the normal flow of the water. The check valve is set for the purpose of avoiding the counter-current of water of the lateral flushing nozzle which is not limited hereby.

In some embodiments, the upper flushing outlet 221 of the integrated mechanical valve 20 and the lateral flushing outlet 41 of the shunt valve 40 are connected to the lateral flushing nozzle 60 via a lateral flushing tee 50 so as to realize the lateral flushing of toilets based on the lateral flushing nozzle 60. In some embodiments, the lateral flushing nozzle 60 is set on the side wall of toilets and is set horizontally along the side wall of toilets to form vortexes on the side wall of ceramic toilets during flushing so as to achieve the effect of flushing the side wall of toilets. In the embodiment, the lateral flushing tee 50 realizes the combination of water outlets to avoid setting multiple pipes.

In the embodiment, a position between the lateral flushing tee 50 and the lateral flushing nozzle 60 is set with a lateral flushing suction pipe 70 for connection. The side wall of the lateral flushing suction pipe 70 is set with a suction tee 71. The suction tee 71 includes two water inlets and one water outlet. One water inlet is connected to the external water way, the other water inlet is connected to the auxiliary liquid tank with the foam liquid of the sealed water tank via a hose, and the water outlet is connected to the lateral flushing nozzle 60. Specifically, the water outlet coincides with the lateral flushing suction pipe 70. The foam liquid is sucked from the auxiliary liquid tank by the Venturi effect of the suction tee 71 and is mixed with the liquid in the lateral flushing suction pipe. In some embodiments, the tank body 11 includes a main liquid tank storing the tap water and an auxiliary liquid tank storing the foam liquid. In some embodiments, the auxiliary liquid tank and the main liquid tank are not connected and are set separately and alternately. In some embodiments, the external water way may be the tap water pipe and other pipes not limited hereby. In some embodiments, the lateral flushing nozzle 60 is fixed on the lateral flushing suction pipe 70 with a fastener (including threaded nut) away from the lateral flushing tee 50 to form the sealed connection with a nozzle sealing ring. In other embodiments, the lateral flushing nozzle 60 can be fixed by other modes which are not limited hereby.

In some embodiments, the lateral flushing suction pipe 70 is set with a lateral flushing flocculent flow film (not indicated in the figure) at the water outlet of the suction tee 71 for the purpose of increasing the streaming potential of liquid flowing through the lateral flushing suction pipe 70 so as to accelerate the mixing of foam liquid and water.

The specific implementation mode includes: when switched to the cleaning function, the foam liquid is sucked from the auxiliary liquid tank to mix by utilizing the unique structure of the suction tee and the Venturi effect, and then is transmitted to the lateral flushing nozzle; at this time, the water pump transmits the water in the water tank from the shunt valve lateral flushing outlet to the lateral flushing nozzle; the water flows through the lateral flushing turbulent film to enhance the rotation effect; and in a lateral flushing jet chamber, the air passes through the air hole of the lateral flushing suction pipe at the lateral flushing nozzle by the Venturi effect and is sucked into the foam mixture liquid and the water mixture at the lateral flushing outlet to form a large number of foams at the filtering net and the lateral flushing nozzle to transmit to the internal side of ceramics. Above operations represent a complete anti-splash function.

In the specific embodiment, the lower flushing outlet 222 of the integrated mechanical valve 20 and the bottom flushing outlet 42 of the shunt valve 40 are connected to the bottom flushing nozzle 421 of ceramic toilets via pipes. The bottom flushing nozzle 421 is fixed on the bottom flushing hole (not indicated in the figure) of ceramic toilets via a nozzle sealing ring 422 and a fastener 423. In the embodiment, the bottom flushing nozzle 421 includes two water inlets and one water outlet. Two water inlets are connected to the lower flushing outlet 222 and the bottom flushing outlet 42 via the water pipes. In some embodiments, the water outlet of the bottom flushing nozzle 421 corresponds to the drainage outlet of the ceramic toilet. Specifically, the fastener 423 is the threaded nut. The bottom flushing nozzle 421 and the nozzle sealing ring 422 are fixed on the bottom flushing outlet of the ceramic toilet by tightening the threaded nut at the bottom flushing outlet. The implementation mode of the bottom flushing water way includes that water at the lower flushing outlet 222 of the integrated mechanical valve 20 or the bottom flushing outlet 42 of the shunt valve 40 is sprinkled to the ceramic elbow discharge outlet by the bottom flushing nozzle 421 to form the siphon jet flushing.

In some embodiments, the tank cover 12 of the sealed water tank 10 is set with an air inlet 121 and an auxiliary buoy 122 corresponding to the air inlet 121. In some embodiments, the auxiliary buoy 122 moves towards the air inlet under the action of the rising water level. The air inlet 121 is closed when the water level rises to a set water level to form a closed air chamber between the tank cover 12 and the tank body 11. When the overall water level in the sealed water tank is lower than the ceramic overflow line, normal operation of the anti-siphon function of the mechanical valve can be ensured so that the overall water level in the sealed water tank 10 is lower than the ceramic overflow line. Specifically, when the flushing function is started, the water level in the water tank quickly lowers down in a short period. At this time, the auxiliary buoy 122 opens the air inlet 121 of the water tank for air feeding into the water tank so as to prevent the negative pressure in the sealed water tank. When the water level in the water tank recovers to the set level and the mechanical valve works abnormally and cannot stop the water feeding, the auxiliary buoy 122 closes the air inlet 121. The mechanical valve continuously feeds, increasing the pressure in the water tank from negative pressure to positive pressure. At this time, under the action of positive pressure, the extra water in the water tank overflows into the ceramic toilet through the shunt valve to form a water seal. The auxiliary buoy 122 closes the air inlet 121 to form positive pressure in the water tank so as to ensure the normal anti-siphon function of the mechanical valve. Specifically, the extra water in the water tank overflows into the ceramic toilet through the bottom flushing outlet of the shunt valve to form a balanced water pressure to prevent back flow of water.

In the embodiment, the shunt valve 40 is set on the tank cover 12 and is connected to the tank cover 12 via the sealing ring of the shunt valve in a sealed way. The DC variable frequency water pump 30 is also connected to the tank body 11 with the sealing ring of the water pump in a sealed way so as to form a sealed water tank controlled by the auxiliary buoy 122.

The specific implementation mode includes: the DC variable frequency water pump provides the kinetic energy for the flushing system to make the water in the water tank flow into the ceramic toilet through the shunt valve; when the flushing function is started, the water level in the water tank quickly lowers down in a short period; at this time, the auxiliary buoy opens the air inlet of the water tank for air inlet into the water tank so as to prevent the negative pressure in the sealed water tank; after the flushing is finished, the air feeding system of the integrated mechanical valve (including the buoy mechanism and the water supplementation inlet) opens to inject water in the water tank; with the rise of the water level, the auxiliary buoy on the tank cover also rises; after the water level in the water tank recovers to the set water level and the integrated mechanical valve works abnormally and cannot stop the water feeding, the auxiliary buoy contacts the air inlet on the tank cover along with the rise of the water level, which forms a closed air chamber in the water tank; with the rise of the water level, the air chamber with positive pressure is formed; under the action of the air chamber with positive pressure, extra water in the water tank will overflow into the ceramic toilet through the flush valve to ensure the CL line (water level safety line) of the water feeding system higher than the water tank overflow line and lower than the ceramic overflow line.

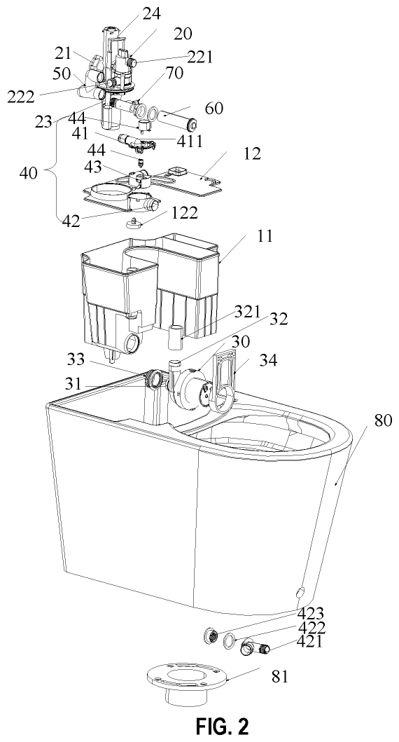

FIG. 2 illustrates a schematic diagram of explosive structure of an embodiment of an intelligent toilet.

The application also provides an intelligent toilet. Referring to FIG. 2, the intelligent toilet includes a ceramic toilet 80 and a flushing system connected to the ceramic toilet 80 with a pipe where the flushing system is the flushing system in any of above descriptions. In some embodiments, the pipes include resin hose. The ceramic toilet 80 is set with a bottom flushing outlet and a lateral flushing outlet. The bottom flushing outlet is at the bottom of the ceramic toilet and corresponds to the drainage outlet. The lateral flushing outlet is on the side wall of the ceramic toilet. In some embodiments, the bottom flushing outlet and the lateral flushing outlet are set with the nozzles sealed via a sealing ring. The bottom flushing nozzle is connected to the bottom flushing outlet of the shunt valve of the flushing system via a hose in a sealed way. The lateral flushing nozzle is connected to the lateral flushing outlet of the shunt valve via an elbow. Refer to the structure setting of above flushing system for details. No more details here. In some embodiments, the intelligent toilet also includes a flange plate 81 at the bottom of the ceramic toilet 80 to drain sewage.

The beneficial effects of this application are that different from the related art, the water storage structure in this application is a sealed water tank which controls the opening and closing of the air inlet on the tank cover to control the positive and negative pressure in the sealed water tank, thereby avoiding the phenomenon of back suction when the water level in the water tank is below the ceramic overflow line. It solves the problems that the overflow level of traditional zero water pressure water tanks must be higher than the minimum ceramic overflow line and there is the requirement for minimum water inlet pressure of no water tank type toilets.

The above content is only the embodiments of the application and does not limit the scope of the patent of the application. All changes of equivalent structure or equivalent process made based on the specifications and figures of the application directly or indirectly applied in other related technical fields are equally included in the scope of patent protected by the application.

What is claimed is:

1. A flushing system, comprising:
a sealed water tank, comprising a tank body and a tank cover connected to the tank body in a sealed way by hot plate welding process; and
an integrated mechanical valve,
wherein the integrated mechanical valve is set on the tank cover and is connected to the tank cover in a sealed way;
wherein the integrated mechanical valve comprises a water inlet, a water supplementation inlet connected to the water inlet, a water outlet at the water supplementation inlet and away from the water inlet, a buoy mechanism at the water supplementation inlet, and a pressing connecting rod structure between the water inlet and the water outlet; and
wherein the buoy mechanism controls switching of the water supplementation inlet based on a water level, and the pressing connecting rod structure controls the switch at the water outlet by pressing.

2. The flushing system according to claim 1, wherein the sealed water tank comprises a DC variable frequency water pump and a shunt valve connected to the water outlet of the DC variable frequency water pump, and
wherein the shunt valve comprises a lateral flushing outlet and a bottom flushing outlet, and the lateral flushing outlet and the bottom flushing outlet are switched by controlling a core of the shunt valve.

3. The flushing system according to claim 2, wherein the water outlets of the integrated mechanical valve comprise an upper flushing outlet and a lower flushing outlet; and
wherein the integrated mechanical valve comprises:
a switching valve core configured to switch the upper flushing outlet and the lower flushing outlet, and
a delay reset mechanism connected to the pressing connecting rod structure in parallel, and the delay reset mechanism slowly switches the switching valve core from the lower flushing outlet to the upper flushing outlet.

4. The flushing system according to claim 3, wherein the upper flushing outlet of the integrated mechanical valve and the lateral flushing outlet of the shunt valve are connected to a lateral flushing nozzle via a lateral flushing tee.

5. The flushing system according to claim 2, wherein the shunt valve comprises a shunt valve core, a rotation shaft on the shunt valve core, a shunt valve cover on one side of the shunt valve core away from the tank body, and a shunt valve motor connected to the rotation shaft and is fixed on the shunt valve cover; and
wherein the shunt valve motor drives the rotation of the rotation shaft to drive the rotation of the shunt valve core so as to open and close the bottom flushing outlet.

6. The flushing system according to claim 4, wherein a lateral flushing suction pipe is set between the lateral flushing tee and the lateral flushing nozzle, a suction tee is set on a lateral wall of the lateral flushing suction pipe, and the suction tee comprises two water inlets and one water outlet;
wherein one water inlet is connected to an external water way, and the other water inlet is connected to the auxiliary liquid tank with the foam liquid of the sealed water tank via a hose; and
wherein the water outlet is connected to the lateral flushing nozzle to suck the foam liquid from the auxiliary liquid tank by Venturi effect of the suction tee and to mix the foam liquid with liquid in the lateral flushing suction pipe.

7. The flushing system according to claim 6, wherein the lateral flushing suction pipe is set with a lateral flushing flocculent flow film at the water outlet of the suction tee.

8. The flushing system according to claim 3, wherein the lower flushing outlet of the integrated mechanical valve and the bottom flushing outlet of the shunt valve are connected to a bottom flushing nozzle at the bottom of a toilet with two water pipes; and
wherein the bottom flushing nozzle comprises two water inlets and one water outlet, and the water outlet corresponds to a drainage outlet of the toilet.

9. The flushing system according to claim 1, wherein the tank cover of the sealed water tank is set with an air inlet and an auxiliary buoy corresponding to the air inlet;
wherein the auxiliary buoy moves towards the air inlet under an action of a rising water level; and
wherein the air inlet is closed when the water level rises to a set water level to form a closed air chamber.

10. An intelligent toilet, comprising a ceramic toilet and a flushing system connected to the ceramic toilet with a pipe, wherein the flushing system comprises:
a sealed water tank, comprising a tank body and a tank cover connected to the tank body in a sealed way by hot plate welding process; and
an integrated mechanical valve,
wherein the integrated mechanical valve is set on the tank cover and is connected to the tank cover in a sealed way;
wherein the integrated mechanical valve comprises a water inlet, a water supplementation inlet connected to the water inlet, a water outlet at the water supplementation inlet and away from the water inlet, a buoy mechanism at the water supplementation inlet, and a pressing connecting rod structure between the water inlet and the water outlet; and
wherein the buoy mechanism controls switching of the water supplementation inlet based on a water level, and the pressing connecting rod structure controls the switch at the water outlet by pressing.
